(19) United States
(12) Patent Application Publication
(10) Pub. No.: US 2012/0179354 A1
(43) Pub. Date: Jul. 12, 2012

(54) Method and device for controlling the pressure inside a fuel tank

(75) Inventor: Harald Hagen, Creussen (DE)

(73) Assignee: Audi AG, Ingolstadt (DE)

(21) Appl. No.: 13/328,298

(22) Filed: Dec. 16, 2011

(30) Foreign Application Priority Data
Dec. 21, 2010 (DE) 10 2010 055 318.2

(51) Int. Cl. F02D 45/00

(52) U.S. Cl. 701/102

(57) ABSTRACT

A method for controlling the pressure inside a fuel tank of an internal combustion engine of a motor vehicle includes relieving the pressure in the fuel tank when reaching a predetermined upper overpressure threshold value. In a device for controlling the pressure in the fuel tank, the pressure in the fuel tank is only relived partially, wherein the pressure relief is less than 20%, preferably less than 10% and optimally less than 5% of the upper overpressure threshold value in order to reduce the emission of volatile hydrocarbons into the environment.

The invention relates to a method and a device for controlling the pressure inside a fuel tank of an internal combustion engine of a motor vehicle according to the preamble of patent claims 1, 2, 9 and 10.

In particular in more recent automobiles with a pressure tight fuel tank the latter is usually produced by blow molding from a plastic material, which can contain at least one metal foil for reducing the permeability of the fuel tank. The plastic materials used for producing fuel tanks, however, often already start to flow above 50° C. which can cause the fuel tank to become irreversibly deformed when an overpressure or negative pressure which lies outside a permissible pressure range, exists in the fuel tank, wherein the permissible overpressure usually is about 380 mbar and the permissible negative pressure is about 150 mbar.

More recent automobiles are further equipped with a device for ventilating and aerating their fuel tank. This device not only allows a gas mixture which is displaced by fuel during refueling to escape from the interior of the fuel tank, but on the other in the case of a greater rise or drop of ambient temperatures, prevents an undesired formation of overpressure or negative pressure in the pressure-tight closed tank as a result of the evaporation of fuel caused by the rise of temperature or, respectively, condensation of fuel vapors caused by the drop of temperature. The device normally includes a controllable tank shut-off valve in form of an electromagnetic valve which is controlled by the motor control unit of the internal combustion engine, two mechanical tank pressure control valves in form of an overpressure valve and a negative pressure valve, which are mostly configured as bypass valves, as well as an activated carbon filter, which is arranged between the valves and the environment and is intended to prevent an undesired release of hydrocarbons from the fuel tank into the atmosphere or the environment. The tank shut-off valve is normally closed and is opened during refueling of the fuel tank to discharge the gas mixture which is displaced by the fuel from the head or gas space of the fuel tank. In addition, the tank shut-off valve is usually opened during operation of the internal combustion engine, when a pressure in the tank measured by a tank pressure sensor exceeds an adjustable overpressure threshold value or falls below an adjustable negative pressure threshold value. The overpressure threshold value and the negative pressure threshold value usually each lie at a distance from the upper or lower limits of the permissible pressure range, wherein the overpressure threshold value is usually about 150 mbar and the negative pressure threshold value is usually about 100 mbar to avoid excessive stress or, in connection with heat an irreversible deformation of the fuel tank. Because normally the tank shut-off valve cannot be controlled when the internal combustion engine stands still, the pressure inside the tank is limited in this operating condition by means of the two tank pressure control valves. The overpressure valve opens automatically when the pressure inside the fuel tank rises to the opening pressure of the overpressure valve which lies above the overpressure threshold value as a result of evaporation of fuel in the fuel tank, for example when ambient temperatures rise or during a residual heating period after turning off the internal combustion engine, while the negative pressure valve opens automatically when the pressure inside the tank falls to an opening pressure of the negative pressure valve which lies below the negative pressure threshold value, as a result of fuel condensing inside the fuel tank for example when ambient temperatures fall. The gas mixture which escapes from the fuel tank when the latter is ventilated is conducted through the activated carbon filter to adsorb the hydrocarbons which are contained in the gas mixture so that only purified air is released into the environment.

However, this procedure has disadvantages: When the internal combustion engine is turned off after a long drive, the internal combustion engine and the exhaust tract emit significant amounts of heat over an extended period of time. Because in particular the exhaust tract oftentimes extends close to the fuel tank, the heat emitted by the exhaust tract can lead to a significant rise of temperature and with this to an increased evaporation of fuel inside the fuel tank, since no cooling takes place through the air flow when the motor vehicle stands still. Since these types of operating conditions occur relatively frequently in many vehicles, the fuel tank is relatively frequently exposed to a pressure which is higher than the overpressure threshold value. This frequent pressure loads in connection with the heating up of the fuel tank or parts thereof can lead to an irreversible deformation of the fuel tank, as mentioned already above and/or decrease the lifetime of the fuel tank.

In addition, the opening pressure of an overpressure valve which serves as protective valve has to be set so that it lies above the overpressure threshold value, at which the tank shut-off valve is opened by the motor control unit. This causes the activated carbon filter to be exposed to a relatively high pressure shock when the overpressure valve is opened, whereby the gas mixture which flows out of the fuel tank is pushed through the activated carbon filter relatively quickly. This is disadvantageous with regard to an even loading of the activated carbon filter, because in this way a portion of the hydrocarbons which are contained in the gas mixture are only absorbed at a significant distance to the inlet of the activated carbon filter or in the case of an already existing stronger loading of the activated carbon filter not absorbed at all, but is released into the environment through the activated carbon filter. In addition, a gas mixture which flows out of the fuel tank at a higher pressure carries along liquid fuel more easily which liquid fuel is also not desired in the activated carbon filter. Further, the strong pressure loss in the fuel tank after opening the overpressure valve leads to an immediate residual gassing of volatile hydrocarbons.

The previously common procedure also leads to problems during operation of the internal combustion engine: when opening the tank shut-off valve for ventilating the fuel tank the gas mixture which escapes out of the fuel tank flows through the activated carbon filter with a relatively great flow rate of 100 to 200 liters per minute, which is also unfavorable with regard to an even loading. In addition, at this flow rates, fuel which is carried along cannot or can only partly be separated even by means of liquid traps. Moreover, strong residual gassing also occurs when opening the tank shut-off valve.

Taking the foregoing into account, the invention is based on the object to reduce the emissions of volatile hydrocarbons into the environment.

This object is solved by a first aspect of the method according to the invention, in that the pressure is only partially part, wherein the pressure relief is less than 20%, preferably less than 10% and most preferably less than 5% of the upper overpressure threshold value.

The invention is based on the idea to strongly reduce the amount of the gas mixture which flows out of the fuel tank at each pressure relief by the small pressure relieve of the fuel tank, so that neither strong pressure surges nor great flow rates have to be absorbed by the activated carbon filter and by this allow for a better adsorption of the hydrocarbons contained in the gas mixtures. In other words the pressure relieve occurs much more frequently than it was previously the case, however, only up to a predefined lower overpressure threshold value.

Preferably, the predetermined upper and lower overpressure threshold value is set so that an irreversible deformation of the fuel tank can still be reliably prevented even in case of a simultaneous heating up of the fuel tank, and so that no impermissible stress on the fuel tank occurs at these threshold values, so that the lifetime of the fuel tank can be extended. For example, the overpressure threshold value can be approximately 150 mbar and the negative pressure threshold value can be approximately 100 mbar.

The method according to the invention is particularly used when the internal combustion engine stands still, to limit the pressure in the fuel tank by the pressure relieve during a so called residual heating period after turning off the internal combustion engine, however, it can also be used during operation of the internal combustion engine.

To ensure that the pressure in the fuel tank during the residual heating period remains as low as possible, a second aspect of the method according to the invention or a preferred embodiment, respectively, provides for the pressure in the fuel tank to be relieved when the internal combustion engine is turned off or immediately after turning off the internal combustion engine, preferably to ambient pressure. For this, the tank shut-off valve can be opened by the motor control unit, by which the tank shut-off valve is controlled for this purpose in the “follow up”. As a result of the pressure relieve, the pressure in the fuel tank is reduced as far as possible before the start of the residual heating period, so that during the residual heating period a maximal amount of fuel can evaporate in the fuel tank, before the pressure in the fuel tank reaches the predetermined upper overpressure threshold value for the first time.

According to a first advantageous embodiment of the method according to the invention and a first variant of the device according to the invention, the partial pressure relieve, in particular during the residual heating period, can take place by means of a mechanical overpressure valve, which opens automatically when the pressure in the fuel tank reaches the upper overpressure threshold value, and closes automatically, after the pressure in the fuel tank is relieved by less than 20% and preferably by less than 10% of the upper overpressure threshold value. This variant has the advantage that the pressure control can take place purely mechanically and the device does not require to be provided with electric current. This allows using the device also in existing motor vehicles, in which after turning off the internal combustion engine and switching off the ignition the current supply is usually interrupted.

This variant has the further advantage that when operating the internal combustion engine the pressure in the fuel tank can be controlled by means of the mechanical overpressure valve and a mechanical negative pressure valve alone, which preferably together with a controllable tank shut-off valve form a device for aerating and ventilation the fuel tank. The tank shut-off valve remains closed during operation of the internal combustion engine and is only opened for refueling the fuel tank, while an overpressure and negative pressure in the fuel tank is decreased by means of the mechanical overpressure valve and the mechanical negative pressure valve. Besides the refueling, this also allows to keep the flow rates of the gas mixture which flows out of the fuel tank to the activated carbon filter low during operation of the internal combustion engine.

As an alternative, according to another advantageous embodiment of the method according to the invention and a second variant of the device according to the invention, the partial pressure relieve can take place by means of a controllable tank shut-off valve which like the overpressure valve is expediently part of a device for ventilating and aerating the fuel tank and is opened briefly when the pressure in the fuel tank reaches or exceeds the predetermined upper overpressure threshold value. Since the amount of the gas mixture which flows through the tank shut-off valve when the tank shut-off valve is open, is determined substantially only by the opening cross section and the opening duration of the tank shut-off valve as well as the overpressure in the fuel tank when the valve is opened, the opening time required for a pressure relieve of less than 20% and preferably less than 10% of the predetermined upper overpressure threshold value can be calculated beforehand, wherein the opening cross section of the tank shut-off valve is fixed and the overpressure in the fuel tank corresponds to the predetermined overpressure threshold value when the valve is opened.

In this case, the device according to the invention advantageously includes a valve opening system for opening the tank shut-off valve, wherein the valve opening system expediently includes a time switch, for example in the form of a relay with a timing element, which is activated after each opening of the tank shut-off valve and ensures that the tank shut-off valve is closed again after the calculated short opening time, before the pressure in the fuel tank has been relieved by more than 20% and preferably more than 10% of the upper overpressure threshold value.

In order to control the tank shut-off valve in dependence on the pressure in the fuel tank, a pressure switch is advantageously provided, which switches when reaching the upper overpressure threshold value and, like the time switch, is part of a switching system for activating the tank shut-off valve.

In a further advantageous embodiment of the invention, the opening of the tank shut-off valve is not only controlled in dependence on the pressure in the fuel tank, but also in dependence on the temperature in the fuel tank or near the fuel tank. The tank shut-off valve is expediently opened only when the pressure in the fuel tank reaches the upper overpressure threshold value and at the same time the temperature in the fuel tank or near the fuel tank exceeds a predetermined temperature threshold value. This ensures that the tank shut-off valve is not opened when the internal combustion engine is turned off after a short drive in which the exhaust tract does not heat up significantly. A temperature switch which is expediently arranged in or on the fuel tank and which is also a part of the switching system for activating the tank shut-off valve, serves for controlling the tank shut-off valve in dependence of the temperature in the fuel tank or near the fuel tank and is preferably connected in series to the pressure switch.

In the following, the invention is explained in more detail by way of several embodiments shown in the drawing. It is shown in

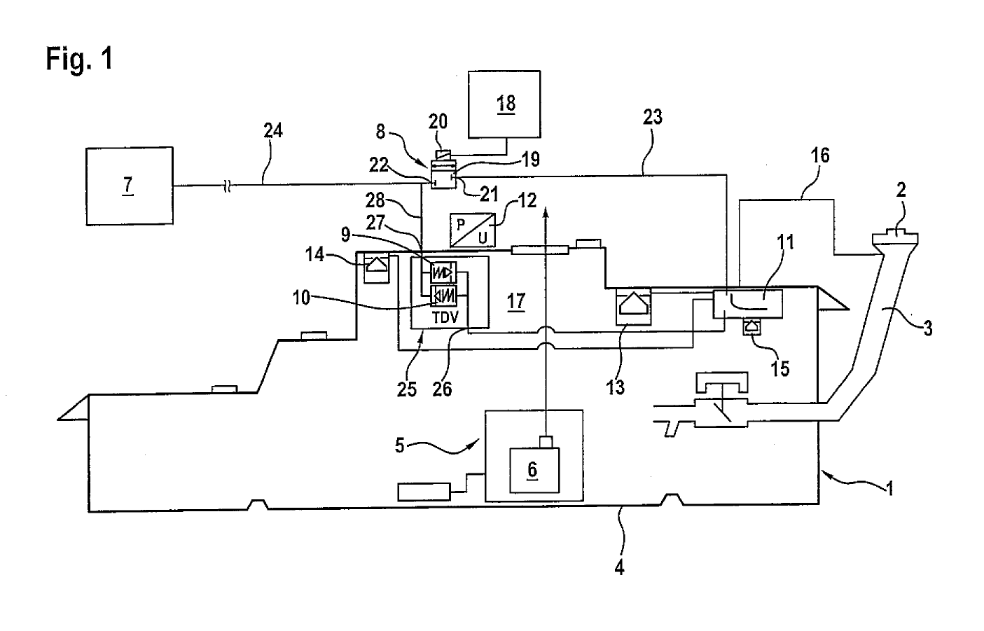

FIG. 1 a schematic view of a fuel tank of an internal combustion engine of a motor vehicle with an aeration and ventilation device, which includes a controllable tank shut-off valve and two mechanical tank pressure control valves in form of an overpressure valve and a negative pressure valve;

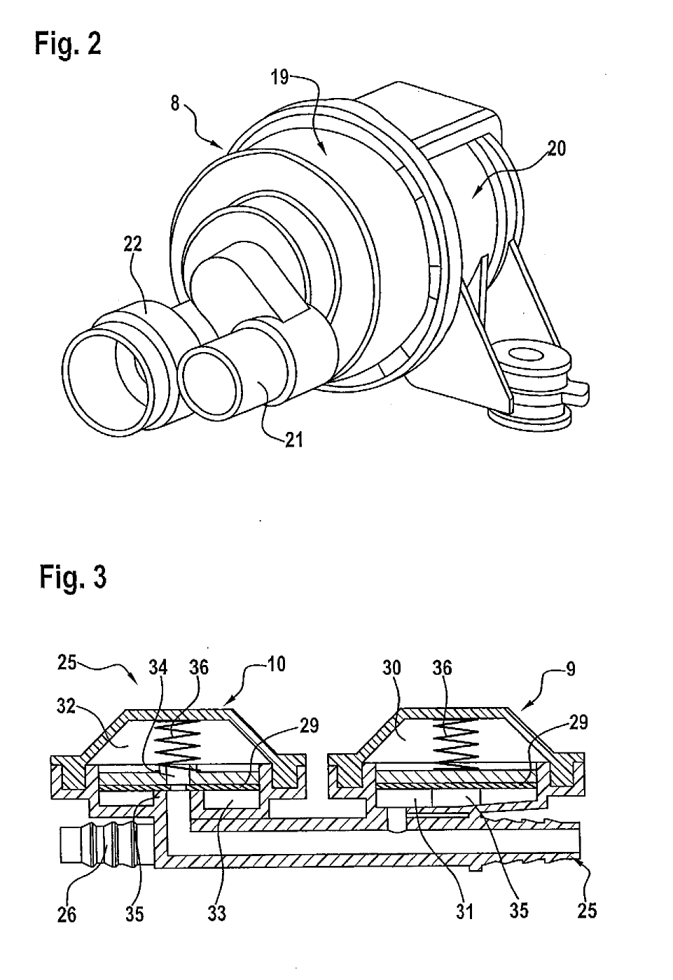

FIG. 2 a schematic longitudinal sectional view of the tank shut-off valve;

FIG. 3 a longitudinal sectional view of the two tank pressure control valves;

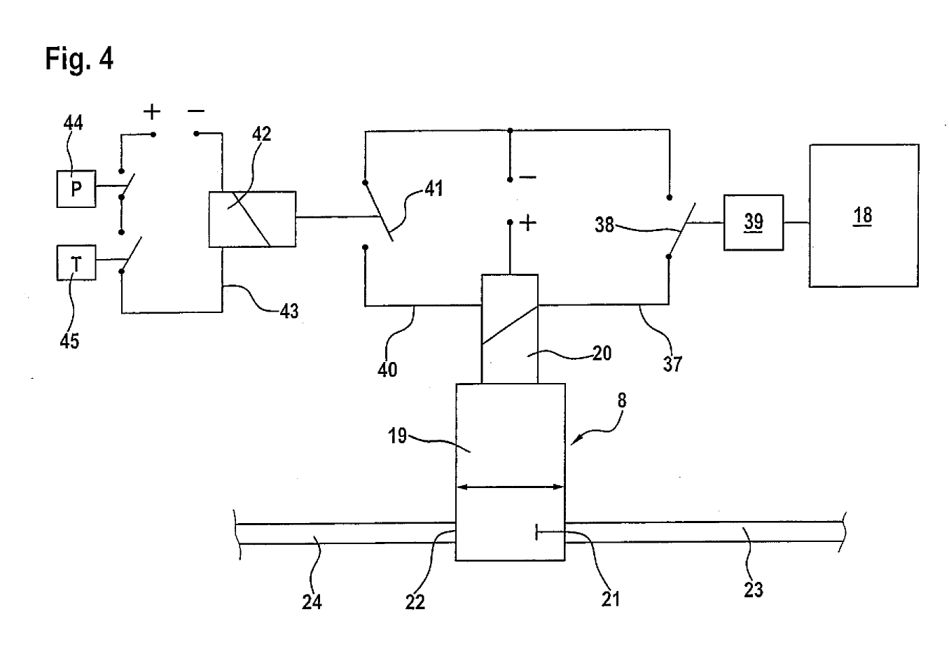

FIG. 4 a schematic representation of a circuit for activating the tank shut-off valve;

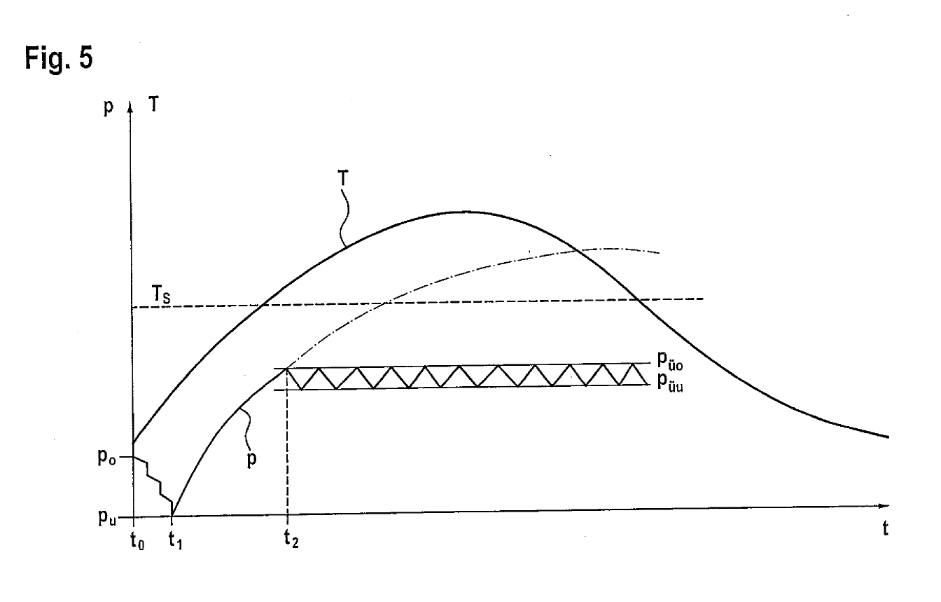

FIG. 5 a diagram of the time dependent temperature and pressure course in the fuel tank after turning off the internal combustion engine in a method for controlling the pressure in the fuel according to the invention.

The fuel tank 1 of a motor vehicle shown in the drawing is a pressure tight fuel tank 1, which was produced by blow molding from a gas and liquid tight sandwich material. For refueling the fuel tank 1 has a filler neck 3 which is closable by a tank lid 2. Near the bottom 4 of the fuel tank 1 is a delivery unit 5 with a fuel pump 6 which is submersed in the fuel.

The fuel tank 1 is equipped with an aeration and ventilation device, with which the pressure in the fuel tank 1 can also be controlled. The aeration and ventilation device includes an activated carbon filter 7, a tank pressure sensor 12 and multiple roll-over-valves 13, 14, 15. The liquid trap 11 which is arranged in the gas and headroom of the fuel tank 1 and borders on the top side of the fuel tank 1 is intended to prevent that when ventilating the fuel tank 1 liquid fuel is carried along with the gas mixture which flows out of the interior of the fuel tank 1 as far as the activated carbon filter 7. The roll over valves 12, 13, 14 are intended to prevent liquid fuel from escaping from the fuel tank 1, when the motor vehicle, for example in case of an accident, slants excessively or overturns. The construction of a liquid trap 11 or of roll over valves is known per se and is therefore not further described.

Further, the filler neck 3 is connected to the liquid trap 11 in a head and gas room 17 of the fuel tank 1 above the highest fuel level via an on-board diagnostic line 16, so that the absence of the tank lid 2 can be detected, to prevent a pressure compensation and escape of hydrocarbons through the filler neck 3. Because no overpressure or negative pressure can form in the fuel tank 1 when the fuel tank lid is absent, the absence of the fuel tank lid 2 can be detected by analyzing the signals of the tank pressure sensor 12.

The activated carbon filter 7 which is arranged outside the fuel tank 7 prevents that volatile hydrocarbons (HC) are released into the environment when the fuel tank is ventilated, and for this purpose contains a filling of activated carbon, which adsorbs hydrocarbons (HC). When the activated carbon filter 7 is loaded with volatile hydrocarbons it is regenerated by aspirating ambient air through the activated carbon filter 7 into the intake tract (not shown) of the internal combustion engine, to flush the filter 7 and to burn the volatile carbohydrates in the combustion chambers of the internal combustion engine.

The tank shut-off valve 8 which is arranged outside the fuel tank 1 is an electromagnetic valve, which is normally closed and can be opened in a clocked manner under the control of a motor control unit 18 of the internal combustion engine. As best shown in FIG. 2, the tank shut-off valve 8 includes a valve part 19 and a valve actuation part 20. The valve part 19 includes a valve seat and a valve member (not shown) which is movable relative to the valve seat as well as a tank port 21 and a filter port 22. The valve actuation part 20 contains an electromagnetic coil and an anchor (not sown) which acts on the valve member. When the electromagnetic coil is excited, the anchor lifts the valve member from the valve seat, whereupon the two ports 21, 22 communicate with one another. As shown in FIG. 1, the tank port 21 is connected to the interior of the fuel tank 1 through a line 23, while the filter port 22 is connected to the activated carbon filter through a line 24.

The two tank pressure control valves 9, 10 which are arranged inside the fuel tank 1 are a purely mechanical overpressure valve 9 and a purely mechanical negative pressure valve 10, which are connected in parallel to form a valve unit or valve assembly 25 and are disposed in the head or gas space 17. The valve unit or valve assembly 25 has a tank port 26 which is connected to the liquid trap 11 and a filter port 27 which is connected downstream of the tank shut-off valve 8 to the line 24 through a line 28.

As best shown in FIG. 4, the two tank pressure control valves 9, 10 each have two chambers 30, 31; 32, 33 which are separated by a membrane 29, one of which chambers communicates with the tank port 26 and one with the filter port 27. The membrane 29 of each valve 9, 10 has an opening 34 and rests on a cylindrical pipe socket 35 around the opening when the valve 9, 10 is closed through which pipe socket 35 in the case of the negative pressure valve 10, the negative pressure chamber 32 communicates with the fuel tank 1 and in the case of the overpressure valve 9 the chamber 30 communicates with the activated carbon filter 7. The membrane 29 is pressed against the free end of the pipe socket 35 by a spring 36 and ensures that the two chambers 30, 31; 32, 33 do not, i.e. not normally communicate with one another when the valve 9, 10 is closed. When the pressure in the tank 1 falls below an opening pressure of the negative pressure valve 10, the membrane 29 of the negative pressure valve 10 is lifted from the pipe socket 35 against the force of the spring 36 as a result of the negative pressure in the negative pressure chamber 32 which communicates with the tank port 25 through the opening and the pipe socket 35, whereby the two chambers 32, 33 are connected to one another upon opening of the valve 10. When the pressure in the fuel tank 1 rises above an opening pressure of the overpressure valve 9, the membrane 29 of the overpressure valve 9 is lifted from the pipe socket 35 against the force of the spring 36 as a result of the pressure in the overpressure chamber 31, whereby the two chambers 30, 31 also are connected to one another upon opening of the valve 9.

When the internal combustion engine stands still, either the tank shut-off valve 8 or the overpressure valve 9 can be used to limit an overpressure which is generated during a residual heating period of the internal combustion engine as a result of a heating of the fuel tank 1 by heat emission of the internal combustion engine, or the exhaust gas tract of the latter in the interior of the fuel tank 1, to an upper overpressure threshold value p_{üo} and thereby prevent an excessive stress on and/or an irreversible deformation of the fuel tank by the heating and the overpressure.

When the overpressure in the fuel tank1 1 is to be limited by means of the tank shut-off valve 8, the switching system shown in FIG. 4 can be used to activate the tank shut-off valve. The switching system includes a first electric circuit 37 which beside the electromagnetic coil in the valve actuating part 20 of the tank shut-off valve 8 contains a switch 38, which under the control of the motor control unit 18 can be opened or closed by an actuator 39. The switch 38 serves for opening the tank shut-off valve immediately after turning off the internal combustion engine to relieve the pressure in the tank 1. A second electric circuit 40 of the switching system is connected in parallel to the electric circuit 37 and beside the electromagnetic coil in the valve actuating part 20 of the tank shut-off valve 8 includes a time switch 41, which is actuated by a relay 42 which has an adjustable timing element. The relay 42 normally disconnects the electric circuit 40 in a state in which the tank shut-off valve 8 is closed. When the relay 42 is supplied with current by a third electric circuit 43 of the switching system, the relay closes the electric circuit 40, whereby the electromagnetic coil of the tank shut-off valve 8 is supplied with current and thereby the normally closed tank shut-off valve 8 is opened. The timing element of the relay 42 ensures that after a short period of time the current supply to the relay 42 is interrupted and with this the time switch 41 is also opened again, whereby the tank shut-off valve 8 is closes again. The opening time of the tank shut-off valve 8, which is adjustable at the timing element is calculated in dependence of the opening cross section of the tank shut-off valve 8 and the desired upper overpressure threshold value p_{üo} so that the pressure in the fuel tank 1 during the opening time of the tank shut-off valve 8 is only partially relieved, preferably by less than 20% and most preferably by less than 10% of the upper overpressure threshold value p_{üo}. At an upper overpressure threshold value p_{üo} of 150 mbar, which corresponds to a positive pressure differential between the interior of the fuel tank 1 and the environment, the pressure relieve to a lower overpressure threshold value p_{üo} is preferably less than 30 mbar and most preferably less than 15 mbar. The third independent electric circuit 43 for current supply to the relay 42 contains a pressure switch 44 as well as a temperature switch 45. The pressure switch 44 is arranged connected in the interior of the fuel tank 1 and switched so that it closes when the pressure in the fuel tank 1 reaches the upper overpressure threshold value p_{üo} and opens when the pressure in the fuel tank reaches the lower overpressure threshold value p_{üu}. The temperature switch 45 is also arranged in the interior of the fuel tank 1 and switched so that it closes when the temperature T in the fuel tank 1 exceeds a temperature threshold value Tₛ of about 50° C. and opens when the temperature T in the fuel tank 1 falls below the temperature threshold value Tₛ

With this switching system the pressure profile in the interior of the fuel tank 1 shown in FIG. 5 can be achieved which pressure profile is represented by the line designated p and is explained in the following. The line designated T shows the temperature profile in the fuel tank 1 during a residual heating period in which the temperature in the fuel tank 1 first increases gradually after turning off the internal combustion engine as a result of heat emission from the exhaust tract and then gradually decreases again.

Immediately after turning off the internal combustion engine at the time point t₀ the tank shut-off valve 8 is opened for a short period of time by alternating opening and closing of the switch 38 several time in short time intervals to adjust the pressure p0 in the fuel tank to the ambient pressure pᵤ until the time point t₁. As a result of the heating of the fuel tank 1 by the heat emission from the exhaust tract the pressure p in the fuel tank 1 subsequently gradually rises again as a result of the evaporation of fuel until the time point t₁, wherein it lags somewhat behind the temperature profile T. When the pressure p at the time t₂ reaches the upper overpressure threshold value p_{üo}, the pressure switch 44 closes. When the temperature T in the fuel tank 1 has previously exceeded the temperature threshold value Tₛ and thus the temperature switch 45 is also closed, the relay 42 is supplied with current for a short period of time and the time switch 41 is closed for a short period of time, until the timing element in the relay 42 interrupts the current supply again. When the time switch 41 is closed, the electromagnetic coil of the tank shut-off valve 8 is supplied with current so that the tank shut-off valve 8 is opened briefly. As already stated, the opening time of the tank shut-off valve 8 is set at the timing element so that the pressure in the fuel tank 1 falls to about the lower overpressure threshold value p_{üu}. After closing the tank shut-off valve 8 the pressure in the fuel tank 1 rises again to the upper overpressure threshold value p_{üo} at which point the tank shut-off valve 8 is opened briefly again by closing the pressure switch 44 and subsequently the time switch 41. This process is repeated until either the temperature T in the fuel tank 1 falls below the temperature threshold value Tₛ again so that the temperature switch opens, or until the pressure p permanently remains below the upper overpressure threshold value p_{üo}, so that the pressure switch 44 no longer opens.

Because only small flow rates of the gas mixture reach the activated carbon filter from the fuel tank 1 and the former is exposed to only very small pressure shocks as a result of the small pressure difference between the upper overpressure threshold value p_{üo} and the lower overpressure threshold value p_{üu}, the volatile hydrocarbons in the gas mixture are absorbed well by the activated carbon filter 7. In addition, the fuel tank is neither exposed to high pressure loads nor to an irreversible deformation by simultaneous exposure to pressure and heat. The overpressure valve 9 in this case serves as protective valve and is configured so that it only opens at an opening pressure which is above the upper overpressure threshold value p_{üo}.

When the pressure p or overpressure is to be limited by means of the overpressure valve 9, the tank shutoff valve 8 remains completely closed after turning off the internal combustion engine. In the overpressure valve 9, the spring 36 and the size of the surface of the membrane 29 are configured or adjusted to one another respectively, so that the overpressure valve 9 opens when the pressure p in the fuel tank 1 reaches the overpressure threshold value p_{üo} and closes again when the pressure has fallen to the lower overpressure threshold value p_{üu} again. With this, a similar pressure profile as in FIG. 5 can be achieved, which however, is independent of the temperature T in the fuel tank 1.

In return, the pressure p inside the fuel tank 1 can also be maintained within a pressure range with is limited upwards by the upper overpressure threshold value p_{üo} and downwards by a negative pressure threshold value pᵤ which is defined by the configuration of the negative pressure valve 10, exclusively by means of the overpressure valve 9 and the negative pressure valve 10. Also during operation of the internal combustion engine the overpressure valve 9 opens automatically when the pressure p in the fuel tank 1 reaches the upper overpressure threshold value p_{üo}. The negative pressure valve 10 opens automatically when the pressure in the fuel tank 1 reaches the negative pressure threshold value pᵤ. Within this pressure range the tank shut-off valve 8 can be opened at any pressure p to ventilate the fuel tank.

### LIST OF REFERENCE SIGNS

1 fuel tank
2 tank lid
3 filler neck
4 bottom
5 delivery unit
6 fuel pump
7 activated carbon filter
8 tank shut-off valve
9 overpressure valve
10 negative pressure valve
11 liquid trap
12 tank pressure sensor
13 roll-over-valve
14 roll-over-valve
15 roll-over-valve
16 on board diagnostic line
17 head or gas room
18 motor control unit
19 valve part tank shut-off valve
20 valve actuation part tank shut-off valve
21 tank port tank shut-off valve
22 filter port tank shut-off valve
23 line
24 line
25 valve unit or valve assembly
26 tank port valve unit or valve assembly
27 filter port valve unit or valve assembly
28 line
29 membrane
30 chamber
31 overpressure chamber
32 negative pressure chamber
33 chamber
34 opening
35 pipe socket
36 spring
37 electric circuit
38 switch
39 actuator
40 electric circuit
41 times witch
42 relay
43 electric circuit
44 pressure switch
45 temperature switch

1-13. (canceled)

14. A method for controlling a pressure in a fuel tank of an internal combustion engine of a motor vehicle comprising partially relieving the pressure in the fuel tank when the pressure reaches a predetermined upper overpressure threshold value, wherein the pressure in the fuel tank is relieved by less than 20% of the upper overpressure threshold value.

15. The method of claim 14, wherein the pressure in the fuel tank is relieved by less than 10% of the upper overpressure threshold value.

16. The method of claim 14, wherein the pressure in the fuel tank is relieved by less than 5% of the upper overpressure threshold value.

17. The method of claim 14, wherein the pressure in the fuel tank is relieved when turning off the internal combustion engine or immediately after turning off the internal combustion engine.

18. A method for controlling the pressure in a fuel tank of an internal combustion engine of a motor vehicle comprising relieving the pressure in the fuel tank when turning off the internal combustion engine or immediately after turning off the internal combustion engine.

19. The method of claim 18, wherein the pressure in the fuel tank is relieved to an ambient pressure.

20. The method of claim 18, wherein the pressure in the fuel tank is relieved by a mechanical overpressure valve, which opens automatically when the pressure in the fuel tank reaches the predetermined upper overpressure threshold value and which closes automatically when the pressure in the fuel tank has been relieved by less than 20% of the upper overpressure threshold value.

21. The method of claim 20, wherein the mechanical overpressure valve closes automatically when the pressure in the fuel tank has been relieved by less than 10% of the upper overpressure threshold value.

22. The method of claim 20, wherein the pressure in the fuel tank is controlled by the mechanical overpressure valve and by a mechanical negative pressure valve when operating the internal combustion engine.

23. The method of claim 18, wherein the pressure in the fuel tank is relieved by a controllable tank shut-off valve which is opened for a short period of time when the pressure in the fuel tank reaches the predetermined upper overpressure threshold value to relieve the pressure in the fuel tank by less than 20% of the upper overpressure threshold value.

24. The method of claim 18, wherein the pressure in the fuel tank is relieved by less than 10% of the upper overpressure threshold value.

25. The method of claim 23, wherein the tank shut-off valve is controlled in dependence on the pressure in the fuel tank.

26. The method of claims 23, wherein the tank shut-off valve is controlled in dependence on a temperature in the fuel tank or near the fuel tank.

27. The method of claim 14, wherein the pressure in the fuel tank is relieved by a mechanical overpressure valve, which opens automatically when the pressure in the fuel tank reaches the predetermined upper overpressure threshold value and which closes automatically when the pressure in the fuel tank has been relieved by less than 20% of the upper overpressure threshold value.

28. The method of claim 14, wherein the mechanical overpressure valve closes automatically when the pressure in the fuel tank has been relieved by less than 10% of the upper overpressure threshold value.

29. The method of claim 27, wherein the pressure in the fuel tank is controlled by the mechanical overpressure valve and by a mechanical negative pressure valve when operating the internal combustion engine.

30. The method of claim 14, wherein the pressure in the fuel tank is relieved by a controllable tank shut-off valve which is opened for a short period of time when the pressure in the fuel tank reaches the predetermined upper overpressure threshold value to relieve the pressure in the fuel tank by less than 20% of the upper overpressure threshold value.

31. The method of claim 14, wherein the pressure in the fuel tank is relieved by less than 10% of the upper overpressure threshold value.

32. The method of claim 30, wherein the tank shut-off valve is controlled in dependence on the pressure in the fuel tank.

33. The method of claim 30, wherein the tank shut-off valve is controlled in dependence on a temperature in the fuel tank or near the fuel tank.

34. A device for controlling a pressure inside a fuel tank of an internal combustion engine of a motor vehicle, comprising a mechanical overpressure valve, which opens automatically when the pressure in the fuel tank reaches a predetermined upper overpressure threshold value, and closes automatically after the pressure in the fuel tank is relieved by less than 20% of the upper overpressure threshold value.

35. The device of claim 34, wherein the mechanical overpressure valve closes automatically after the pressure in the fuel tank is relieved by less than 10% of the upper overpressure threshold value.

36. A device for controlling a pressure in a fuel tank of an internal combustion engine of a motor vehicle, comprising
a controllable tank shut-off valve; and
a valve opening system for opening the controllable tank shut-off valve when the pressure in the fuel tank reaches a predetermined upper overpressure threshold value, wherein the valve opening system comprises a time switch which closes the tank shut-off valve after a short period of time, before the pressure in the fuel tank has been relieved by more than 30% of the upper overpressure threshold value.

37. The device of claim 36, wherein the time switch closes the tank shut-off valve before the pressure in the fuel tank has been relieved by more than 20% of the upper overpressure threshold value.

38. The device of claim 37, wherein the valve opening system comprises a pressure switch.

39. The device of claim 38, wherein the valve opening system comprises a temperature switch

40. The device of claim 39, wherein the pressure switch and the temperature switch are connected in series.
